(19) United States
(12) Patent Application Publication
(10) Pub. No.: US 2006/0190312 A1
(43) Pub. Date: Aug. 24, 2006

(54) Method for assembly of projects and system for practicing method

(76) Inventors: Kimon Onuma, Pasadena, CA (US); Thomas Dalbert, Waianae, HI (US); Alfred Man, Hong Kong (CN)

Correspondence Address: LAW OFFICE OF MAI VU PARE, 1821 WILSHIRE BLVD., SUITE 530, SANTA MONICA, CA, 90403, US

(21) Appl. No.: 11/362,421

(22) Filed: Feb. 23, 2006

Related U.S. Application Data
(60) Provisional application No. 60/656,136, filed on Feb. 23, 2005.

(51) Int. Cl. G06F 17/50

(52) U.S. Cl. 705/7

(57) ABSTRACT

The present invention teaches a method and system for assembling projects. The method comprises the steps of 1) gathering and assembling expert knowledge; 2) identifying relevant parameters and defining rules; 3) programming key parameters into a core system; and 4) providing a computer based medium for users to input information, coordinate information, update changes or modifications by multiple users and receive output m various formats.

This application claims the benefit of a priority date based on Provisional Application 60/656,136.

### BACKGROUND OF INVENTION

The building, specifying, designing, constructing and managing of buildings, interiors, and products requires the coordination of numerous experts in a wide range of disciplines. There is no one occupation or profession that can address all of the types of expertise needed to assemble or plan a project. Examples of the wide range of experts or individuals that may have relevant knowledge may include general contractors, electrical engineers, structural engineers, mechanical engineers, plumbing consultants, economists, environmentalist, citizen groups, civil engineers, or any other group or individual that may have knowledge and/or experience to contribute to a project. These parties will be referred to hereinafter as “stakeholders.”

The present model for assembling building projects does not require that these various stakeholders integrate their work simultaneously but rather these stakeholders work in parallel. In the example of a building project, it is the responsibility of an architect to coordinate the information of the various consultants.

Prior art methods of assembly do not facilitate the ability of all of the stakeholders to simultaneously work together and integrate their efforts. For information to be shared a stakeholder must first decide whether a decision or piece of information should be shared, communicate this information to other stakeholders and determine whether this information must or should be communicated, and decide to what level of detail it must be defined.

This disjointed, non-integrated method of assembly does not maximize the knowledge held by each of the participants to a project. It may not be obvious to one stakeholder that his decisions directly impact the decisions of another. A stakeholder may not see the link between the task he is performing with the responsibilities of another stakeholder, thus he will not feel compelled to communicate a decision he made with the architect. To some extent, each stakeholder is only concerned about “his part of the job.” With this mentality, costly errors can occur when the decisions of one stakeholder negatively impact decisions of another.

The present invention provides a method and system to integrate the work and efforts of various stakeholders. Employing the method of the present invention, relevant parameters are determined in the early stages of planning. A software allows for the linking and modeling of multiple parameters relevant to a project (hereinafter referred to as “parametric modeling”). By utilizing the software component of the present invention, problems such as identifying equipment needed for an operating room can be instantly determined based on the requirements of a hospital.

### SUMMARY OF INVENTION

The present invention applies the knowledge of experts to computer software applications resulting in an improved method for assembling projects. While the present invention is discussed predominantly in the context of building construction, its applications are much broader and include but are not limited to the assembly of equipment, products, and devices. There are two components to the present invention: a human intelligence component and a software component.

I. Human Intelligence Component of Present Invention

The present invention is an improved method for assembling projects that incorporates human knowledge and expertise with technology and automation.

The human component involves the use of experts and before a project is started to evaluate the needs and requirements of a given project. On first use of the present invention, experts collaborate early on to evaluate the particular needs of a proposed project. The experts selected will vary depending on the type of project to be constructed.

From this information gathering stage, categories of information that may impact the building of a project are identified. These categories bear importance in customizing a software component of the present invention.

II. Software Application Component of Present Invention

Once the relevant categories of information are identified, these categories can be written into the software and linked so that the impact of changes in one category of information can be seen in another category of information. This procedure is called parametric modeling.

The software component of the invention can work off-line as well as on the Internet and can run on an HTTP server. It can be placed in an organization's Intranet for optimized planning collaboration. In the Internet version, the software can be accessed with a standard web browser. In a preferred embodiment of the invention, a free browser plug-in technology is used for the graphical user interface.

While numerous variations to the invention may exist and still fall within the scope of protection granted by the patent, there are two core components to the present invention that exists in all embodiments. First, there is an expert knowledge component that is a collaboration of experts prior to assembling a project to evaluate assembly systems and define categories of information that should be linked to result in the optimal integration of efforts; and second, there is a software component that incorporates the information gathered from expert knowledge and links graphical planning tools with database information technology.

### BRIEF DESCRIPTION OF DRAWINGS

FIG. 1 shows an overview of the present invention.

FIG. 2 shows a flow chart of the present invention as applied to the planning of a hospital facility.

FIG. 3 is a representative user interface provided by the software component of the present invention as viewed from a computer device.

### DETAILED DESCRIPTION OF THE INVENTION

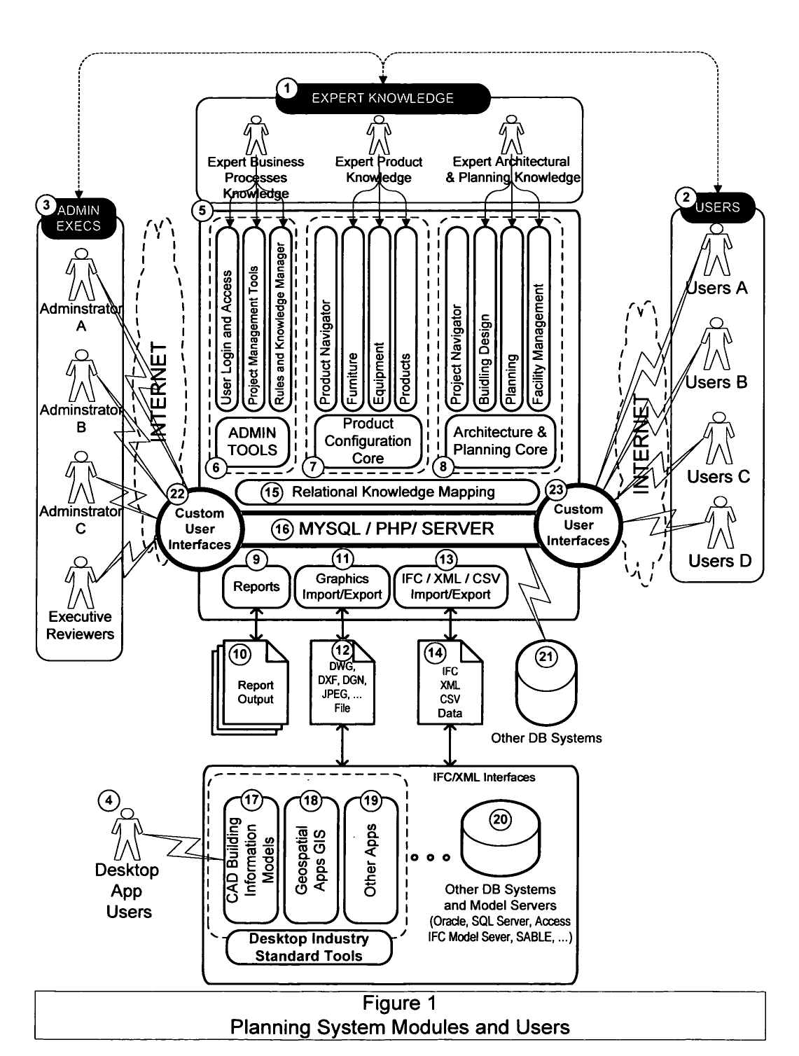

I. FIG. 1: Details of the Core System

A preferred embodiment of the present invention is shown in FIG. 1. The example in FIG. 1 relates to an embodiment of the present invention geared towards building projects.

Various experts 1 in business processes, building and material information, product information, and architectural and planning professionals are interviewed early on in a project to identify parameters important in the planning and building of a project.

The focus of this system is to capture from experts 1 as much expert knowledge as possible from any source that is reliable. The expert knowledge may also come from an individual's intimate knowledge that can come only from an accumulation of professional experience. The knowledge may exist in a variety of mediums including paper, electronic formats, or solely in the memory of an expert.

Following the expert interviews, rules are created from the relevant parameters of information collected from the experts. Examples of such rules may include desk unit sizes, typical number of employees in a given department, or numbers of restrooms needed for a certain number of employees. This information is stored the system database further organized by categor. This stored information is also accessible in future projects. The knowledge accumulates the more the system is used. Relevant links between the data are accumulated as relational tables.

A Product Configuration Core 7 is contained within the system database and includes rules gathered from product experts. The Product Configuration Core further comprises a product navigator to quickly locate and jump to specific projects. Furniture specific information may be stored in furniture modules, and other equipment and product information may be stored in equipment and product modules. Said modules are stored within the Product Configuration Core.

An Architecture & Planning Core 8 is contained within the system database and includes rules related to architecture and planning gathered from architecture and planning experts. The Architecture & Planning Core further comprises a project navigator to quickly locate specific projects or sections of projects. Said Architecture and Planning Core further comprises building design modules, planning modules, and facility management modules containing facts and rules related to the respective categories of information.

The number and types of cores contained in the present invention are unlimited and in no way should the present invention be construed as being limited to the Product Configuration Core or Architecture and Planning Core.

As information and knowledge are collected, more and more Relational rules of information are defined through Relational Knowledge Mapping 15. The relational rules are stored in the database as tables. The relational rules are identified and can be adjusted at a later date or for different situations to change the result. This allows the rules to be refined over time or tested for various scenarios. This mapping 15 is the core of the system, connecting the dots between the various data and knowledge in the database. Relational Knowledge Mapping provides means to allow users to see numerous links between categories of information that may have otherwise been hidden.

The Relational Rules describe which categories of information contained in databases are related and define the relationships held between the categories.

The relational rules are organized as nested conditional statements and are stored in the system database. The more relational rules entered into the system, the more information can be instantly obtained relating to a given project.

An example of a relational rule organized as a nested conditional statement could be written as follows:
If designing a hospital for 1500 patients then at least 12 acres and parking for 500 cars are required. If the hospital is in Los Angeles parking for 700 cars is needed, if it is in New York then parking for 300 cars is needed.
If you build this hospital from concrete then the cost per square foot for construction is going to be $300.00 in Los Angeles. If you build it from concrete then allow for 2.75% of the total area for columns, if you build it from steel then allow for 2.1% of the total are for columns.
If the hospital is a children's hospital then allow for 2 operating rooms per 200 patients. If the operating room is going to use endoscopic equipment and use boom arms with equipment mounted in the ceiling then allow for X amount of electrical support for that equipment per room. The minimum area for the operating room should be 20 feet by 20 feet and have an adjoining room for preparation that is 10 feet by 5 feet. The mechanical system to support this operating room should be able to handle X number of air changes per hour.

As can be seen above, the nested conditional statements allow for a multitude of parameters and complex scenarios to be linked and written as one rule. The input for the conditional statements and the logic of how they are related to each other can be locked or adjustable. The logic of how they are related allows the user to not worry about the complex relationships and focus just on generating rapid decisions using accurate data from the system.

The Administrator 3 can manage and adjust these conditional statements to adjust for logical rules or specific needs. The creation and management of these conditional statements as they apply to specific business processes is what drives the system. The conditional statements are then linked to and from graphical representations that can be viewed and manipulated. The system then allows the user to quickly make decisions based on the output. The system is a collection of conditional statements that without the proper interface would be difficult or very time consuming to manage.

Administrative and Executive Reviewers 3 can set the rules and access to the system. There can be many levels of administrators each with their own task and ownership of specific data or processes. For example there may be an administrator who's task is solely related to financial needs of the user and another administrator who's task is limited to building and safety concerns of the user. Administrators can set up user log in and access privileges, manage projects and templates, and manage rules. Executive reviewers can access projects created by users. The level of access and types of reports can be customized for each user.

The user 2 does not need to understand all the details or parameters that link the rules. The user can focus on entering data into the system that will trigger outputs based on the rules that provide the output. The mapping of these rules and relationships and the ability to constantly refine and update these rules, as the system is used more, increases the amount of knowledge in the system. The software component of the present invention further links relational databases to graphics tools to yield data output in the form of charts, graphics 11, reports 9, or other formats. The pairing of graphical two dimensional and three dimensional elements allows users to better visualize the impact of adjustments in parameters that are typically not linked to two dimensional and 3 dimensional software tools.

Desktop application users 4 can access the system. Data from the system can be exported 13 into desktop applications to provide useful information. Data coming from CAD 17, GIS 18, or other applications 19 can be used by the system to provide output as well. For example, an Excel table with a list of room names and room numbers can be imported into the system for further manipulation and access from various user interfaces.

The present invention also opens up the potential of finding common threads between different industries that were not as apparent in prior art methods. By providing a location where business methods, logic, rules and knowledge can be stored in a methodical way, a database is created that allows information to be accessed and linked in a rapid way. The present invention finds common threads by design filters and analyzes those common threads to create categories of information and then establishes the relationships between these threads to drive planning decisions.

In the present invention, experts 1 ideally meet early on to exchange and identify parameters and categories of information that are relevant to the planning and/or assembly of a project in the early stages of a project. While this takes place in the beginning of a project, it is important to note that expert knowledge can be entered in the system at different points in time, and it is not required that all expert knowledge be entered at the same time.

Custom User interfaces 22,23 are created that allow users, administrators, and executive reviewers to enter and request information without knowing technical programming language. The custom user interfaces may be provided over the Internet through a standard browser or it may be provided off line. Multiple users may be working on separate or the same projects and each user can share their own project or collaborate with others through the Internet.

Information is provided in a form that is usable to the user such as reports 9, 3D building information models, DWG, DXF, DGN, or JPEG files 12. Said output from the present invention can also feed back into system for future use, and is retained as accumulated knowledge and logic of the system over time.

II. Compatible Technologies with the Present Invention

In a preferred embodiment of the invention, custom databases, custom API, web plug-ins such as GDL, custom GDL objects, Javascript, Java applets, custom GDL, BIM templates, IFC links, CAD, 3D and 4D are different technologies that can be used with the system. This list is not exhaustive and is not limited to this base set. There are other technologies being evaluated and new ones being built as part of the Planning System that fit into the system.

Other systems can be built as part of the Planning System or other systems that exist can also be used as part of the system. The system is designed in a way for maximum extendability. Data tables and interoperablity allow for links to and from other databases. IFC, XML, and CSV Data Import and Export 13 are set up to communicate with other databases and programs. The design of the system is to allow for maximum interoperability with other systems. IFC or Industry Foundation Classes are an international standard format for data. XML is Extensible Markup Language, and CSV is Comma Separated Values such as Excel files.

Other databases and systems that exist can be linked. GIS 18 and CAD 17 Building Information Models are examples of desktop industry tools that may be linked to the present invention to provide information.

The system comprises MYSQL and PHP database tools 16. The system can run on various server types including Apache and Oracle 16. The main feature of the present invention is that it comprises a relational database that is accessible through the Internet. All modules of the system are linked though the database.

The technologies to support the planning system are integrated. All technologies used should be able to “talk” to each other and be interoperable in order to be integrated effectively. This includes all technologies that are built as part of the present invention. Proprietary systems and ones that are not data centric will not work within this blueprint.

Data and knowledge not contained in an interoperable format can still be used however. Such data is extracted, filtered, and entered in the software component of the planning system. For example, if a user has knowledge about how to plan a hospital operating room, and that knowledge is not documented or is contained in a printed document, the method of the present invention would still allow this knowledge to be incorporated in the software component of the invention by extracting the data and manually entering it into the core system.

III. FIG. 1 and Transactions for Specifying Building Products

The present invention can also be used to match design requirements of performance specifications of building products to actual product data. Using FIG. 1 to illustrate this capability, User A is an architect that is specifying the design of a hospital and defines the requirement for furniture and equipment needed for an operating room via the appropriate user interfaces 23. These requirements may be performance driven to define each piece of equipment. For example there may be a need for an operating room table that is of size x,y,z and has legs made of stainless steel and rollers that lock and operating room lights with lumens of X. These requirements can be defined in the system by the Administrator 3, and User A can specify them along with the size of the operating room. The Architecture and Planning Core 7 would be accessed to specify the size and configuration of the operating room and the The Product Configuration Core 8 would be accessed to specify the operating room table and lights.

The conditional relationships of how much light is needed in that specific operating room would be contained in the system in the form of a rule from the expert knowledge 1. Administrators for the requirements of the lighting level of that particular operating room could control or even change those requirements. User A would then have a report in the database with all the specifications of that room. The next step would be to match those specifications with all available products for operating room tables.

Manufacturers' data could be found in other databases 21 and linked to the system. There may be three companies that can supply the needs defined for the operating room lights. Company A, B, C could all manufacture lights that meet the specifications. User B in 2, could evaluate the offerings from Company A, B, C and decide on Company B, based on price and performance specifications. There could be multiple transactions to match the best fit for operating room tables and lights that match the requirements of User A.

The example above could happen for all levels of building products or equipment. It could be kept at a generic level of “lights are needed in an operating room” or it could be resolved to a very specific level of the exact type and maker of that light and the cost of it. The system is flexible enough to go from very abstract requirements to very specific and since it is all in a database, can be linked to other specific data such as the cost of that light today.

The next step would be to actually place an order for X number of lights from Company B, based on the needs defined in the system.

The process described above can either happen very early on in the concept stage of pricing the hospital and operating room and could follow through to the actual construction. In this way more accurate costs and definition of requirements can be established on a continual basis through the life of a project. It also allows for rapid “what if” analysis of options.

IV. Planning of a Hospital

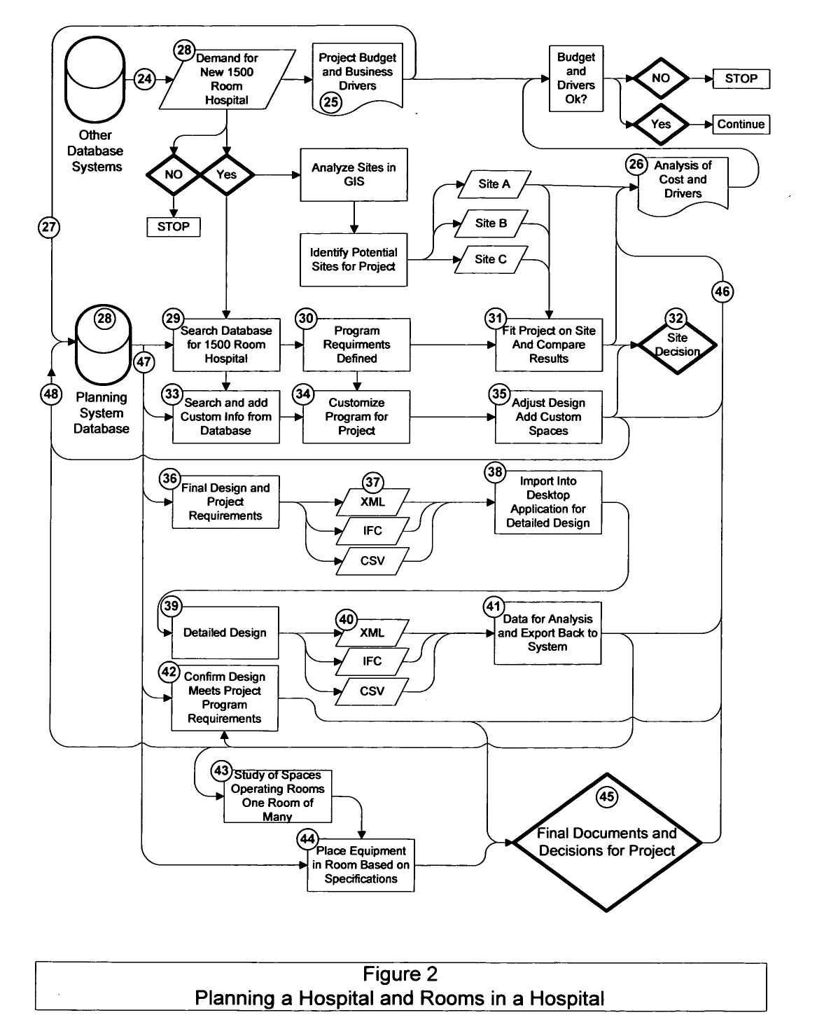

The present invention can be described in the context of planning a construction of a hospital facility. FIG. 2 illustrates a flow chart showing the various tasks and functions the system can accomplish in the context of planning a hospital facility. In FIG. 2 a medical group is evaluating the need to build a new hospital in a community. This process involves many decisions and evaluations of demand and financial viability of the project.

First the group might evaluate whether there is a demand for a new 1500 room hospital. The group may access information relating to population demographics that is stored in financial databases or Geographic Information System (GIS) databases 24. This information can be linked to the system 27 to generate reports and useful output. From this information they may determine there is no need, in which case they stop.

If it appears the population demographics would support a new hospital initial budget and business drivers of the project may be defined 25. Analysis reports can be prepared to evaluate whether cost and other business driver goals are being met 26. These analysis reports can be on an ongoing basis and with rapid “what if” scenarios to compare and adjust different scenarios. The analysis and resulting data presented to the user then allows for decisions to be made to continue, stop or adjust the process.

Project requirements and budget requirements entered into the system can later be adjusted as situations change. This can be updated and adjusted dynamically as project requirements shift. Traditionally this type of data updating does not happen on a regular basis and is more linear. Therefore this step is something that is typically out of sync as a project progresses. If the goals can be met, the group can proceed to identify potential sites.

The group can search available databases for three possible sites that meet their budget and business criteria. This would occur in GIS software and the data and coordinates of the three sites would be transferred to the system to create a graphical view of the site plan shape and size.

After the three sites have been analyzed based on the project requirements and one site has been identified for analysis the program requirements and plans can be inserted on this site for analysis 31. This can happen on multiple sites for early studies on the best fit based on many factors including to but not limited to cost, location, best fit and other business drivers. For example a small site may require a multi story parking structure and a larger site may not. The cost versus benefits on one site over the other involves many decision points. In early planning, being able to repeat processes accurately and come as close as possible to actual total costs supports sound decision making. After careful analysis, an optimal site can be determined 32. The scheme can be customized by the user, by accessing the database and adding or subtracting from the first option 33. This gives complete flexibility and a rapid way of defining custom scenarios. A Customized program is created 34. Adjustments can be made and spaces can be further customized to create the final scheme 35.

Final Design and Project Requirements can be produced by the system in multiple formats. The system can generate reports or analysis directly in the user interface in the web enabled environment or can be output to various format for further analysis 36. Various formats of data can be exported from the system including XML, IFC, and CSV.

The final design and project requirements information can be imported into Desktop applications such as CAD, BIM Excel and other applications that can use the data from the system for detailed analysis 38. At this point it is separated from the system data. Following the import of information into Desktop Applications, detailed design is completed and prepared and reported back to the system 39. Output in various formats for importing back to the database in the system 40.

Data that is exported back to the web enabled system database can now be analyzed and compared to original requirements defined in item 36. 41

The original requirements are compared to the submitted scheme 42. This can happen on a continual basis as the project evolves or as the requirements adjust.

The level of detail and analysis using the data from the system can go all the way to a single room or individual components 43. In this example the analysis is for a single operating room in the hospital and the study of specific operating room equipment. This can happen at each room level.

Equipment specifications can be retrieved from databases and allow the user to place equipment in the room and evaluate result 44. The final documentation for the project can be submitted and analyzed against original requirements 45.

Continuous updates can be made as the parameters in the project change 46. This monitors the trajectory of the project cost and other data to confirm it is inline with the changing business needs. Continuous data from the system is fed into each process and continuous feedback into the system takes place, allowing the system to keep current 48.

The integrated process described above all the way from site selection to the electrical load of a piece of equipment can be stored in the system and thus be analyzed. The integration of all the pieces could trigger a scenario that automatically recalculates the results in cost specification or need for the project. For example if the population and market demands change it may be required to increase the number of beds from 1500 to 2500.

This can be set up to be automatic. Changes in the number of beds could automatically determine the new number of equipment pieces needed to accommodate the increase in beds. In the opposite direction if the total cost of the hospital goes over a certain amount the project may need to be reconsidered or stopped. There could be external forces that also affect these decisions. For example if the cost of steel doubles in 6 months as the project is in the planning stages, the direction of the project could drastically shift.

This tight integration of data, decisions and time, are processes that are typically done manually or in very inefficient methods. This efficiency problem is what ends up costing money or jeopardizing the entire project. Fast accurate data that is tightly integrated is what this system provides

At each step of this process, data analysis on cost and other business factors are being analyzed automatically or semi automatically.

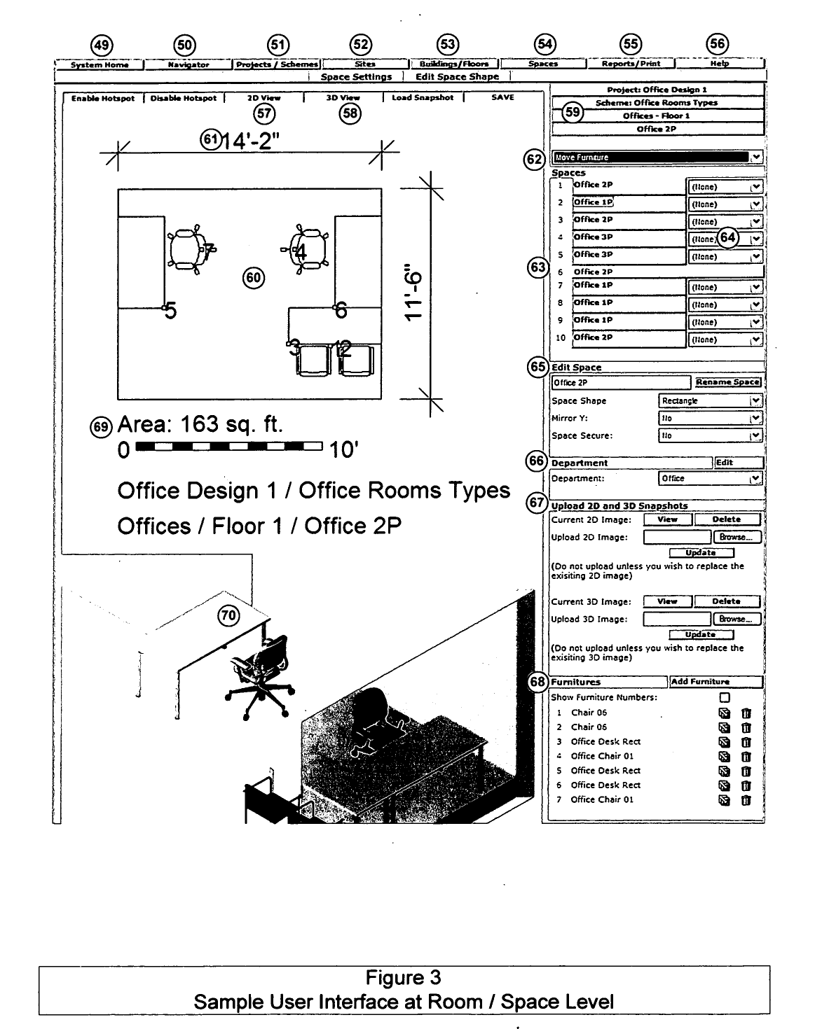

V. FIG. 3: User Interface

FIG. 3 is an example of a user interface created by the system providing the user a graphical interface to provide voluminous data in a meaningful format. The user interface is from a standard web browser, Internet Explorer. This is one of thousands of different views in the interface that are designed in a way to be task specific.

A System Home button is a starting point and link to other systems by type, such as schools, offices, hotels, courtrooms, residential, medical, government, city and other 49. Each category of systems has unique characteristics all running on the same system. Custom systems for specific types of use can also be created.

A Navigator button is an entrance into a database to search across multiple projects/schemes/buildings/floors/spaces and allows the user to jump to that particular view 50. Thousands of files accessible through here.

A Projects/Schemes button allows users to create multiple projects and multiple schemes 51. Users can also view templates schemes that administrators control, view schemes from other users if shared, or share their own schemes. Users can also copy other schemes and make them their own project for customization.

A Sites button allows the user to jump to a site view that could have multiple buildings and other site features such as roads and parking 52. XML and IFC files can be imported and exported from this level to bring in entire buildings with multiple floors to the site. From the site level, users can jump to any building. Site level also has a graphical user interface that allows users to manipulate and change/move site features in 2d and 3d. Any movement of the graphical interface updates the underlying data about that particular project/scheme.

The Buildings/Floors button 53 provides an interface to individual buildings. Each building can have multiple floors and each floor can have multiple spaces. Graphical interface allows user to edit floor shape and add or subtract rooms from a database of prebuilt space or starting from a blank space. An Import feature allows opening a “comma separated value” table such as from Excel that has a list of spaces and areas and automatically generates the corresponding spaces in the floor plan graphic. Floor plan graphic has the option to show or hide background plans of existing buildings, show new spaces on top of the background, abstract the new spaces as bubble diagrams and show all this in 2d or 3d. Floor plan graphic is editable by the user. As floors and rooms are edited the area is tracked in the database.

The Spaces button 54 allows the user to see the view at the space level. A typical arrangement of a user interface on each level is a graphical 2D and 3D view on the left hand side. There is the option to show 2D or 3D views. Users can also zoom into the 2d or 3d and rotate the 3d view.

Furniture can be moved, the space shape can be stretched. Navigation buttons are located along the top row. Controls on the right to jump to other spaces or edit the current space may be provided. Furniture can be added or subtracted from a furniture database. Each piece of furniture is tracked in the database. The numbers illustrated in the 2D plan, 2, 3, and 4, 5, 6, 7 are keyed to each piece of furniture in the space.

The Report/Print button 55 allows the user to access multiple reports and output about the current project or other projects.

Schemes can be accessed from this button. Various types of reports from simple room reports to more complex cost estimates or specific reports such as list of staff in each space can be generated from here. Comparisons between different schemes can also be generated to check current schemes compared against another standard or scheme.

The Help button 56 provides access to contextual help and “how to” documentation.

The 2D View button 57 turns the graphical interface to 2d view only.

The 3D View button 58 turns the graphical interface to 3d view only.

An Address/Location Level button provides a path that tells the user which project, scheme, building, floor, space he is in and the ability to click on an upper level and jump to another view.

The 2D Plan View of Space/Room area provides a 2D view of the room. In this interface the user can “grab” and move furniture or the space shape. Editing in the graphical interface in 2D also updates the 3D view as well as the database.

The dimensions of a room dynamically change as the user edits the shape of the space 61.

The user can select various actions he wishes to take listed on the pull down menu 62. Move Furniture/Rotate Furniture/Edit Space/Rotate Space are examples of the available actions.

A Spaces Room List provides a list of spaces on the floor 63. To move to another space the user clicks on the name of the room.

Adjacency requirements can be edited to show the relationship from one space to the next by pulling down a drop down menu and selecting a space 64. A graphical line is shown at the floor level between spaces that are designated needing to be adjacent or near each other.

In an Edit Space feature 65 edit space name, shape, mirroring of shape or designate if a space is secure or not.

In a Department Color Coding feature 66—Departments can be assigned to individual space and the user can also create department categories that can be shown as color coded in the floor plan view.

Department color coding can be turned on or off in 2d and 3d view at the floor plan level. A department's area is also shown when searching the Navigator 50 or when adding template spaces at the floor level.

An Uploading Images feature allows for the editing of the graphical interface of the 2D 60 and 3D views 70 and allows for adjustment of the space, and furniture. The option here is to take a “snapshot” of the current view in 2d and 3d and save it as a standard jpeg file to include in reports or to show a static view as a snapshot for users that do not wish to load the editable model.

A Furniture edit feature allows the user to add from a database of project specific furniture or delete furniture that is in the space. Furniture can also be placed in a specific location in the plan, and also moved above the floor such as placing a computer on a desktop.

The area of the room is shown on the graphical interface and is dynamically updated as the user stretches the space 69. The total area is also tracked in the database and used in reports to calculate total areas of the room, floor, building or multiple buildings. Areas can also be compared against predefined standards to confirm that the user is within range of a requirement.

Within the 3D View area of the user interface 70, the user can zoom in on or turn, the view matches what is in the 2d view and in the database.

As viewed in FIG. 3, the user interface provides the user access to voluminous quantities of information in an organized, user-friendly format.

VI. Details of the Software Component of the Present Invention.

In the preferred embodiment, the present invention is a flexible system allowing relatively easy customization. Not excluding possible extensions depending on its application, the system consists of the following parts:
1. Login System to authorize the user and to keep track of the user's current projects. The login system can be accessed with a standard web browser. It includes an administrator's user management system.
2. Administrator's interface to set up and update the logic rules and upload historical data that drive the system. The logic and rules are created as nested conditional statements that drive the system. The analysis and interpretation of the needs that are driven by a specific process, such as the design process of a new project, or the process requirements and technical specifications of a piece of equipment, are made part of the logic rules in the present invention.
3. User interface to set up project files, to select or duplicate and adjust the rules and the historical data, and to duplicate earlier projects and templates. The user can adjust the rules set by the administrator by duplicating a base set of rules. The user cannot delete or edit the original set of rules set by the administrator.
4. Multiple Graphical User Interfaces to Design in 2D and 3D. Large project sites to details of room furnishings can be designed in present invention. Each level of detail has its own user interface to keep the amount of information manageable for the user. This concept is core to the present invention. The user interface is analyzed and created in a way to simplify the experience of the user, yet has a very powerful back end to support integrated decision making. An object of the invention is to limit the amount of information required from the user to a manageable level per interface.
The software component of the present invention may have thousands of pages or user interface views that are interconnected and ties the logic together. After saving a design, the server side database keeps track of the changes for the user to return any specific design at a later date. It also allows settings from one level to update parts within the other levels of the design process. In the preferred embodiment of the invention, the graphical user interface is geospatially linked to a location, however this is not always the case.
5. Sharing of Projects. A user interface to automatically send current projects files for other users to review and comment on.
6. Export functions from the graphical user interface to save the projects at all levels in a large variety of formats (dwg, dxf, dwf, MicroStation, 3ds, LightScape and others).
7. Extension/Plug-in (API) to directly read the raw data from the server side database. This re-creates automatically the project with all its levels in a local CAD file. The same extension can also be used to create the database file to upload the data of a CAD file from the desktop to the database on the HTTP server. There is export and import capability to applications such as Archicad, Solibri, Enterprixe, Autocad, Sketchup, Microstation, ESRI and other GIS Applications, and other software packages.
8. The interoperability of the projects created is guaranteed with the export possibilities to IFC format. In addition, specific features such as room name, use, square footage, geometry etc. can be exported to XML.

VII. Supporting Technology

The following technology is being used to drive each of the above parts—in most cases; this technology can be adjusted to the users needs as well.
1. The Login System is driven by a server side scripting language (in the standard version: PHP) and a database to collect the user and login information (standard: MySQL DB).
2. PHP and MySQL DB is also used for the administrative CMS. Historical data is collected from the clients and/or part of extensive in-house planning-data collection. The rules can be quite simple or very complex calculations and derivations of existing information.
3. A relational database connects the user login data with the project files and the individual project settings. Planning templates created by the administrator can be duplicated and adjusted by the user. Again, in the standard version, PHP and MySQL are used.
4. For the graphical interface, “intelligent” 3D objects are developed with Java Applications and GDL Technology. Intelligence is being built into the script of these highly parametric objects themselves. Movement of macro objects within the master objects is being tracked by the master object. JavaScript is being used to communicate with the master object to relate the changes back to PHP script which in turn updates the database with the latest settings. The next time a user views a specific project, the data from the database is again in reversed order related back into the object. This feature of the planning system allows for the following:
   a. Management of large number of users and projects
   b. Connection of the online system to desktops and pulling the data back into the online system.
   c. Constantly connecting data to the graphical user interface
   d. A systematic tool to collect knowledge, logic and rules into the planning system.
   e. A parametric process of using accurate data in the early stages of the design and planning process.
   f. The Planning System can “learn” over time as more logic, rules and knowledge are collected into the system. This knowledge then becomes a resource for future projects. The collective nature of this knowledge from a large group of experts is a resource.
   g. Ability to explode the online system GDL objects into individual elements on the desktop and track those elements back into the online system.
   h. Multiple objects for different detail levels to be used on different user interfaces for the user to interact with the same project on multiple levels.
5. In the current system, PHP is used to send mail with embedded links to any address the user wishes to inform about the project and to let others view the project in development. This also includes any collaboration efforts: multiple users across the globe can work together on a “live” project. Each update by another party is instantaneously visible for the collaborator. Special locking or authorizations can be used for each party to be participating at any level.
6. The GDL Technology allows for direct export of many different CAD formats. The exported objects can be used directly as 2D and 3D objects in various standard CAD software packages.
7. An in-house developed extension (API), created using C++, AutoLisp, to CAD software such as Autocad, ArchiCAD, SketchUP, and others allows users to recreate online projects in all their levels of detail with one click of a button after downloading the raw data from the online MySQL Database. In reversed order, the user can also save a project as raw data and upload this data into the online database. The uploads and downloads are handled by PHP as well.
8. Industry Foundation Classes (IFC) are developed by the International Alliance for Interoperability. They allow for sharing and data exchange capabilities in the building design, construction and facility management sector of the industry. The IFCs are an internationally accepted standard that is gaining momentum in the last few years. It is being used by institutions and the commercial sector.

The system is flexible enough so that it can be translated into any other server side language or connected to any other type database server. This makes the data, knowledge and logic accumulated in the system “future proof”. The focus is to constantly create links to other systems.

### CONCLUSION

The present invention focuses on capturing process and logic into a system to create a process that can be repeated, verified and used with other systems. The present invention is comprised of a novel method for assembling projects and enabling technologies to practice said method that creates a unique tool for a wide range of business processes.

1. A method for assembling projects and system to practice said method comprising the steps of:
gathering knowledge and information from experts;
identifying relevant parameters from said expert knowledge and information;
identifying links between said parameters;
creating rules based on said links and said knowledge;
writing said rules into a software component of the present invention;
storing said rules in a core contained within said software component;
said software component comprising means to provide user interfaces, link databases, integrate information from said databases, and coordinate data and information with two dimensional and three dimensional images.

2. The method for assembling projects and system of practicing said method wherein said software component generates output with data and information generated from said output becoming additional rules.

3. Said method and system of practicing said method of claim 1 further comprising a web enabled means to provide the software component over the Internet through a standard browser.

4. The method and system of practicing said method of claim 1 for purposes of planning and assembling buildings.

5. The method and system of practicing said method of claim 4 wherein said experts provide business processes knowledge, product knowledge and architectural and planning knowledge.

6. The method and system of practicing said method of claim 4 wherein said software component comprises a web enabled means to provide the software component over the Internet.

7. The method and system of practicing said method of claim 1 wherein the software component comprises the following elements:
a login page;
an administrator's interface;
a user's interface;
multiple graphical user's interface to design in two dimension and three dimension;
sharing of projects function;
output; and
and extensions/plugins.

8. A method for assembling projects and system to practice said method comprising the steps of:
interviewing experts with knowledge related to said project;
identifying relevant parameters from said expert knowledge and information;
identifying links between said parameters;
creating rules based on said links writing said rules into a software component of the present invention;
storing said rules in a core contained within said software component;
said software component comprising means to provide user interfaces, link databases, integrate information from said databases, and coordinate data and information with two dimensional and three dimensional images.
